(19) United States
(12) Patent Application Publication
(10) Pub. No.: US 2017/0344913 A1
(43) Pub. Date: Nov. 30, 2017

(54) SYSTEM AND METHOD FOR DETECTING EFFECTIVE TRAVEL OPTION AND TICKETS BETWEEN A SOURCE AND DESTINATION WITH DIFFERENT MODES OF TRANSPORTS

(71) Applicant: CONFIRM TICKET ONLINE SOLUTIONS PRIVATE LIMITED, Bangalore (IN)

(72) Inventors: SRIPAD VAIDYA, Bangalore (IN); KOTHA DINESH KUMAR, Bangalore (IN)

(21) Appl. No.: 15/607,630

(22) Filed: May 29, 2017

(30) Foreign Application Priority Data
May 29, 2016 (IN) 201641007053

(51) Int. Cl. G06Q 10/04; G06F 17/30; G06Q 10/02; G06Q 50/30

(52) U.S. Cl. CPC G06Q 10/04; G06Q 50/30; G06F 17/3056; G06Q 10/025

(57) ABSTRACT

The embodiments herein provide a system and method for effective detection and identification of travel options between a source and destination pair. The system and method identifies a plurality of alternative travel options between a source and destination pair for effective utilization of unused reservation quotas in a plurality of modes of travel. Currently, there are no systems available to enable travelers with information on alternative reservation options. The system and method utilizes graph data-structure to determine the available travel options between given source and destination pair is provided. The system and method enables travelers to reserve tickets by connecting or chaining multiple vehicles in the same or different modes of travel between given source and destination pair. The system also enables an effective travel solution by identifying a plurality of journey break options.

### CROSS-REFERENCE TO RELATED APPLICATION

The embodiments herein claims the priority of the Indian Provisional Patent Application with the serial number 201641007053 filed on Feb. 29, 2016 and subsequently postdated by 3 Month to May 29, 2016 with the title, “SYSTEM AND METHOD FOR DISCOVERY OF EFFECTIVE TRAVEL OPTION AND TICKETS BETWEEN A SOURCE AND DESTINATION FOR A PLURALITY OF MODES OF TRAVEL”, and the contents of which is included entirely as reference herein.

### BACKGROUND

### Technical field

The embodiments herein are generally related to a system and method for effective detecting best suitable travel options between a source and destination. The embodiments herein are particularly related to a system and method for identifying a plurality of alternative travel options between a source and destination. The embodiments herein are more particularly related to a system and method for determining all possible and best suited travel options between a source and destination through a graph data structure.

### Description of the Related Art

The process of booting travel tickets and determining travel options are often limited by a number of factors. When the travel tickets are sold-out for a pair of source and destination on a particular date in a mode of travel preferred by a traveler, the travelers generally seek other or alternate modes of travel. However, the travelers are many times not aware of alternative quotas and reservation options in their preferred mode of travel.

Currently, there are no systems available to enable travelers with the information on alternative quotas and reservation options between a source and destination pair, thereby generating a condition that the travelers are not aware of the vacant tickets or vacancy positions, even though a vacancy is open for tickets between a source and destination. This leads to the travelers choosing a less preferred mode of travel and an ineffective utilization of ticket reservation options.

Hence, there is a need for a system and method to enable an effective detection, identification and utilization of travel options between a source and destination. There is also a need for an effective identification of a plurality of alternative travel options between a source and destination points.

The above mentioned shortcomings, disadvantages and problems are addressed herein and which will be understood by reading and studying the following specification.

### OBJECTS OF THE EMBODIMENTS

The primary object of the embodiments herein is to provide a system and method for an effective identification of travel options between a source and destination points.

Another object of the embodiments herein is to provide a system and method for detection and identification of a plurality of alternative travel options between a source and destination points.

Yet another object of the embodiments herein is to provide a system and method for effective utilization of unused reservation quotas between a source and destination points in a plurality of modes of travel.

Yet another object of the embodiments herein is to provide a system and method to determine the available travel options between given source and destination points through or by utilizing a graph data-structure.

Yet another object of the embodiments herein is to provide a system and method to enable the travelers to reserve tickets by connecting or chaining multiple or a plurality of vehicles in the same or different modes of travel between the given source and destination points.

Yet another object of the embodiments herein is to provide information to the user regrading a travel schedule, price for different modes of transport, availability of tickets and the like, even when the ticket booking portal are not accessible.

Yet another object of the embodiments herein is to provide a system and method to provide an effective travel solution by identifying a plurality of journey break options on a plurality of modes of travel between a given source and destination points.

Yet another object of the embodiments herein is to provide a system and method to provide travelers with information on all available travel options between a source and destination pair in a plurality of modes of travel.

Yet another object of the embodiments herein is to provide a system and method to provide predictions of a travel ticket getting confirmed from unconfirmed status based on analysis of historical data on ticket confirmation.

These and other objects and advantages of the embodiments herein will become readily apparent from the following detailed description taken in conjunction with the accompanying drawings.

### SUMMARY

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

The various embodiments herein provide a system for effective detection, identification and booking of travel options between a source and a destination points.

According to an embodiment herein, a system comprising a hardware processor and a memory storing instructions that are run on the hardware processor for effective detection, identification and booking of travel options between a source and a destination pair, is provided. The system comprises a client module configured for enabling one or more users to specify one or more travel or journey related details. The one or more travel or journey related details comprise name of a source station, name of a destination station, preferred time and date of travel and preferred mode of transport. The system comprises a server communicatively coupled to the client module. The server is configured for presenting one or more available travel options to the user for selecting a most suitable travel option for booking travel tickets. A travel option comprises a direct travel or a travel with a break-up journey comprising one or more hops between a source station and a destination station using one or more modes of transports. The one or more modes of transports comprise a train, a bus, a taxi and a flight. The server comprises an authentication module configured for authenticating each user using one or more personal details provided by the user. The one or more personal details comprise a mobile number, Facebook credentials and Google credentials. The authentication module is further configured for generating a unique token number for identifying each user associated with the system. The server also comprises a real time ticket discovery engine configured for searching one or more available travel options for the user to reach the destination station based on a seat availability in one or more modes of transport between the source station and the destination station. The real time ticket discovery engine is further configured for preparing and sharing a travel itinerary with the user from the source station to destination station by chaining or linking one or more modes of transport based on seat availability. The server further comprises an availability check module configured for checking and retrieving a seat availability data from a plurality of ticket booking portals for one or more modes of transport and providing the retrieved data to the real time ticket discovery engine. The server still further comprises a booking engine configured for booking one or more tickets for the user based on the most suitable travel option selected by the user. One or more details related to the booked ticket are stored in a database.

According to an embodiment herein, the real time ticket discovery engine is further configured for searching an alternate option to reach the destination station when no seats are available in any mode of transport. The alternate option to reach the destination station comprise a wait listed ticket in one or more modes of transport with a highest chance for confirmation, a hop journey using a combination of more than one modes of transport and a longer route with confirmed tickets.

According to an embodiment herein, the system further comprises a historical data store configured for storing historical data related to availability of tickets, change of ticket status, price of tickets, delay in arrival/departure of the selected mode of transport and preferred mode of transport for each user.

According to an embodiment herein, the system further comprises a data processing engine configured for processing a logged historical passenger name record number (PNR) data available from one or more ticket booking portals along with plurality of journey details for one or more users to determine the trends related to confirmation of wait-listed tickets for a particular mode of transport. The plurality of journey details comprise a class of travel, a booking status, a journey date, a quota and final charting status. The data processing engine is further configured for grouping the historical passenger name record number (PNR) data into one or more groups and marking whether particular ticket is confirmed or wait-listed. The one or more groups comprise a weekend season group, a normal season group, a holiday season group, a quota-wise group and a class-wise group.

According to an embodiment herein, the system further comprises a prediction engine configured for processing the historical passenger name record number (PNR) data logged using the data processing engine to determine a threshold cancellation value related to each mode of transport using one or more machine learning algorithms. The threshold cancellation value is used for determining the chances of a ticket booking getting confirmed.

According to an embodiment herein, the system further comprises a staging database configured for storing raw data collected from all the ticket booking portals associated with the system. The data processing engine is further configured for moving the raw data to a production database after cleansing, processing and validation.

According to an embodiment herein, the system further comprises a cache layer configured for storing plurality of details related to one or more modes of transport associated with the system. The plurality of details comprises schedule and seat availability for each mode of transport. The cache layer is further configured for caching the plurality of details related to one or more modes of transport for a pre-determined period of time.

According to an embodiment herein, the real time ticket discovery engine is further configured for searching the one or more available travel options for the user based on one or more factors. The one or more factors comprise fastest way to reach the destination station, waiting time, number of hops, cheaper mode of transport, convenience for the user and the preference of the user.

According to an embodiment herein, the system is further configured for identifying one or more stations for which the seat availability changes by changing the source station and by keeping the destination station constant and vice versa. The identified one or more stations are marked with a data change flag. The one or more stations marked using data change flag are used by the real time ticket discovery engine for determining seat availability between a source station to a destination station, a source station to an intermediate station and an intermediate station to a destination station.

According to an embodiment herein, the system is further configured for utilizing unused reservation quotas/tickets available in special category between the source station and the destination station in one or more modes of transport. The reservation quota/special category comprises reservation quota, senior citizen quota, ladies quota, very important person (VIP) quota and military quota.

According to an embodiment herein, the real time ticket discovery engine is further configured for searching the one or more available travel options for the user using a graph data structure. The graph data structure comprises a connected graph with plurality of nodes representing one or more hop/intermediate stations between the source station and the destination station.

According to an embodiment herein, the system is further configured for sharing one or more predictions with the user about a status of a travel ticket getting confirmed from an unconfirmed status based on analysis of historical data on ticket confirmation.

According to an embodiment herein, the system is further configured for providing a Web interface or a mobile interface to the one or more users for effective discovery and booking of one or more travel options between the source station and the destination station.

According to an embodiment herein, a method for effective discovery and booking of travel options between a source and destination pair is provided. The method comprises the steps of enabling one or more users to specify one or more travel journey related details using a client module. The one or more travel journey related details comprise name of a source station, name of a destination station, preferred time and date of travel and preferred mode of transport. The method further comprises authenticating one or more users using one or more personal details using an authentication module. The one or more personal details comprise a mobile number, Facebook credentials, and Google credentials. One or more available travel options are searched for the user to reach the destination station based on seat availability in one or more modes of transport between the source station and the destination station using a real time ticket discovery engine. The one or more modes of transport comprise train, bus, taxi and flight. A travel itinerary is prepared and shared with the user from source station to destination station by chaining one or more modes of transport based on availability of tickets using the real time ticket discovery engine. Seat availability data is checked and retrieved from a plurality of ticket booking portals for one or more modes of transport and the retrieved data is provided to the real time ticket discovery engine using an availability check module. One or more tickets are booked for the user based on the most suitable travel option selected by the user. One or more details related to the booked ticket are stored in a database.

According to an embodiment herein, the method further comprises searching an alternate option to reach the destination station in case no seats are available in any mode of transport. The alternate option to reach the destination station comprises a wait listed ticket in one or more modes of transport with highest chances of confirmation, a hop journey using a combination of more than one modes of transport and a longer route with confirmed tickets.

According to an embodiment herein, the method further comprises processing a logged historical passenger name record number (PNR) data available from one or more ticket booking portals along with plurality of journey details for one or more users to determine trends related to confirmation of wait-listed tickets for a particular mode of transport using a data processing engine. The plurality of journey details comprise class of travel, booking status, journey date, quota and final charting status.

According to an embodiment herein, the method further comprises grouping the historical passenger name record number (PNR) data into one or more groups and marking whether particular ticket is confirmed or wait-listed. The one or more groups comprise a weekend season group, a normal season group, a holiday season group, a quota-wise group and a class-wise group.

According to an embodiment herein, the method further comprises processing the historical passenger name record number (PNR) data logged using the data processing engine to determine a threshold cancellation value related to each mode of transport using one or more machine learning algorithms through a prediction engine. The threshold cancellation value is used for determining the chances of a ticket booking getting confirmed.

According to an embodiment herein, the method further comprises searching the one or more available travel options for the user based on one or more factors. The one or more factors comprise fastest way to reach the destination station, waiting time, number of hops, cheaper mode of transport, convenience for the user and the preference of the user.

According to an embodiment herein, the method further comprises identifying one or more stations for which the seat availability changes by changing the source station and by keeping the destination station constant and vice versa. The identified one or more stations are marked with a data change flag. The one or more stations marked using data change flat are used by the real time ticket discovery engine for determining seat availability between a source station to a destination station, a source station to an intermediate station and an intermediate station to a destination station.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

### BRIEF DESCRIPTION OF THE DRAWINGS

The other objects, features and advantages will occur to those skilled in the art from the following description of the preferred embodiment and the accompanying drawings in which:

FIG. 1 illustrates a block diagram of a system for effective discovery and booking of travel options between a source and destination pair, according to one embodiment herein.

FIG. 2 illustrates a detailed block diagram of a system for effective discovery and booking of travel options between a source and destination pair, according to one embodiment herein.

FIG. 3A and FIG. 3B illustrate charts comprising of example historical passenger name record number (PNR) data collected from a ticket booking portal before and after grouping respectively, according to one embodiment herein.

FIG. 4 illustrates an example support vector machine algorithm plot, according to one embodiment herein.

FIG. 5 illustrates an example situation depicting a manner in which the real time ticket discovery engine makes use of data change flag for identifying different quota based booking options for the user, according to one embodiment herein.

FIG. 6 illustrates an example connected directed graph depicting nodes as cities and relations as possible transport between the nodes, according to one embodiment herein.

FIG. 7 illustrates an example situation depicting a manner in which the real time ticket discovery engine searches all possible routes between source and destination with best travel options like fastest, low price with availability in buses and trains, according to one embodiment herein.

FIG. 8 illustrates an example situation depicting a manner in which the real time ticket discovery engine searches hop journey travel option with shortest route, according to one embodiment herein.

FIG. 9 illustrates an example situation depicting a manner in which the real time ticket discovery engine searches lower price travel options for the user to reach the destination with hop journeys, according to one embodiment herein.

FIG. 10 illustrates a flowchart explaining the method for effective discovery of travel options between a source and destination pair, according to one embodiment herein.

FIG. 11 illustrates an exemplary method of travel option determination, according to one embodiment herein.

FIG. 12 illustrates an exemplary method for determining alternate ticketing options in a same train, according to one embodiment herein.

FIG. 13 illustrates a flow diagram that enables marking data change flags, according to one embodiment herein.

FIG. 14 illustrates an exemplary method for determining alternate ticketing options in a plurality of modes of transport, according to one embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a system for effective discovery and booking of travel options between a source and a destination pair.

According to an embodiment herein, a system comprising a hardware processor and a memory storing instructions that are run on the hardware processor for effective detection, identification and booking of travel options between a source and a destination pair, is provided. The system comprises a client module configured for enabling one or more users to specify one or more travel journey related details. The one or more travel journey related details comprise name of a source station, name of a destination station, preferred time and date of travel and preferred mode of transport. The system comprises a server communicatively coupled to the client module. The server is configured for presenting one or more available travel options to the user and for booking travel tickets for most suitable travel option selected by the user. A travel option comprises a direct travel or a break journey with one or more hops between source station and destination station using one or more modes of transport. The one or more modes of transport comprise train, bus, taxi and flight. The server comprises an authentication module configured for authenticating each user using one or more personal details provided by the user. The one or more personal details comprise a mobile number, Facebook credentials and Google credentials. The authentication module is further configured for generating a unique token number for identifying each user associated with the system. The server also comprises a real time ticket discovery engine configured for searching one or more available travel options for the user to reach the destination station based on seat availability in one or more modes of transport between the source station and the destination station. The real time ticket discovery engine is further configured for preparing and sharing a travel itinerary with the user from source station to destination station by chaining one or more modes of transport based on seat availability. The server further comprises an availability check module configured for checking and retrieving seat availability data from a plurality of ticket booking portals for one or more modes of transport and providing the retrieved data to the real time ticket discovery engine. The server still further comprises a booking engine configured for booking one or more tickets for the user based on the most suitable travel option selected by the user. One or more details related to the booked ticket are stored in a database.

According to an embodiment herein, the real time ticket discovery engine is further configured for searching an alternate option to reach the destination station in case no seats are available in any mode of transport. The alternate option to reach the destination station comprises a wait listed ticket in one or more modes of transport with highest chances of confirmation, a hop journey using a combination of more than one mode of transport and a longer route with confirmed tickets.

According to an embodiment herein, the system further comprises a historical data store configured for storing historical data related to availability of tickets, change of ticket status, price of tickets, delay in arrival/departure of the selected mode of transport and preferred mode of transport for each user.

According to an embodiment herein, the system further comprises a data processing engine configured for processing a logged historical passenger name record number (PNR) data available from one or more ticket booking portals along with plurality of journey details for one or more users to determine trends related to confirmation of wait-listed tickets for a particular mode of transport. The plurality of journey details comprise class of travel, booking status, journey date, quota and final charting status. The data processing engine is further configured for grouping the historical passenger name record number (PNR) data into one or more groups and marking whether particular ticket is confirmed or wait-listed. The one or more groups comprise a weekend season group, a normal season group, a holiday season group, a quota-wise group and a class-wise group.

According to an embodiment herein, the system further comprises a prediction engine configured for processing the historical passenger name record number (PNR) data logged using the data processing engine to determine a threshold cancellation value related to each mode of transport using one or more machine learning algorithms. The threshold cancellation value is used for determining the chances of a ticket booking getting confirmed.

According to an embodiment herein, the system further comprises a staging database configured for storing raw data collected from all the ticket booking portals associated with the system. The data processing engine is further configured for moving the raw data to a production database after cleansing, processing and validation.

According to an embodiment herein, the system further comprises a cache layer configured for storing plurality of details related to one or more modes of transport associated with the system. The plurality of details comprises schedule and seat availability for each mode of transport. The cache layer is further configured for caching the plurality of details related to one or more modes of transport for a pre-determined period of time.

According to an embodiment herein, the real time ticket discovery engine is further configured for searching the one or more available travel options for the user based on one or more factors. The one or more factors comprise fastest way to reach the destination station, waiting time, number of hops, cheaper mode of transport, convenience for the user and the preference of the user.

According to an embodiment herein, the system is further configured for identifying one or more stations for which the seat availability changes by changing the source station and by keeping the destination station constant and vice versa. The identified one or more stations are marked with a data change flag. The one or more stations marked using data change flag are used by the real time ticket discovery engine for determining seat availability between a source station to a destination station, a source station to an intermediate station and an intermediate station to a destination station.

According to an embodiment herein, the system is further configured for utilizing unused reservation, quotas/tickets available in special category between the source station and the destination station in one or more modes of transport. The reservation quota/special category comprises reservation quota, senior citizen quota, ladies quota, very important people (VIP) quota and military quota.

According to an embodiment herein, the real time ticket discovery engine is further configured for searching the one or more available travel options for the user using a graph data structure. The graph data structure comprises a connected graph with plurality of nodes representing one or more hop/intermediate stations between the source station and the destination station.

According to an embodiment herein, the system is further configured for sharing one or more predictions with the user about a status of a travel ticket getting confirmed from an unconfirmed status based on analysis of historical data on ticket confirmation.

According to an embodiment herein, the system is further configured for providing a Web interface or a mobile interface to the one or more users for effective discovery and booking of one or more travel options between the source station and the destination station.

According to an embodiment herein, a method for effective detection, identification and booking of travel options between a source and destination pair is provided. The method comprises the steps of enabling one or more users to specify one or more travel journey related details using a client module. The one or more travel journey related details comprise name of a source station, name of a destination station, preferred time and date of travel and preferred mode of transport. The method further comprises authenticating one or more users using one or more personal details using an authentication module. The one or more personal details comprise a mobile number, Facebook credentials and Google credentials. One or more available travel options are searched for the user to reach the destination station based on seat availability in one or more modes of transport between the source station and the destination station using a real time ticket discovery engine. The one or more modes of transport comprise train, bus, taxi and flight. A travel itinerary is prepared and shared with the user from source station to destination station by chaining one or more modes of transport based on availability of tickets using the real time ticket discovery engine. Seat availability data is checked and retrieved from a plurality of ticket booking portals for one or more modes of transport and the retrieved data is provided to the real time ticket discovery engine using an availability check module. One or more tickets are booked for the user based on the most suitable travel option selected by the user. One or more details related to the booked ticket are stored in a database.

According to an embodiment herein, the method further comprises searching an alternate option to reach the destination station in case no seats are available in any mode of transport. The alternate option to reach the destination station comprises a wait listed ticket in one or more modes of transport with highest chances of confirmation, a hop journey using a combination of more than one modes of transport and a longer route with confirmed tickets.

According to an embodiment herein, the method further comprises processing a logged historical passenger name record number (PNR) data available from one or more ticket booking portals along with plurality of journey details for one or more users to determine trends related to confirmation of wait-listed tickets for a particular mode of transport using a data processing engine. The plurality of journey details comprise class of travel, booking status, journey date, quota and final charting status.

According to an embodiment herein, the method further comprises grouping the historical passenger name record number (PNR) data into one or more groups and marking whether particular ticket is confirmed or wait-listed. The one or more groups comprise a weekend season group, a normal season group, a holiday season group, a quota-wise group and a class-wise group.

According to an embodiment herein, the method further comprises processing the historical passenger name record number (PNR) data logged using the data processing engine to determine a threshold cancellation value related to each mode of transport using one or more machine learning algorithms through a prediction engine. The threshold cancellation value is used for determining the chances of a ticket booking getting confirmed.

According to an embodiment herein, the method further comprises searching the one or more available travel options for the user based on one or more factors. The one or more factors comprise fastest way to reach the destination station, waiting time, number of hops, cheaper mode of transport, convenience for the user and the preference of the user.

According to an embodiment herein, the method further comprises identifying one or more stations for which the seat availability changes by changing the source station and by keeping the destination station constant and vice versa. The identified one or more stations are marked with a data change flag. The one or more stations marked using data change flag are used by the real time ticket discovery engine for determining seat availability between a source station to a destination station, a source station to an intermediate station and an intermediate station to a destination station.

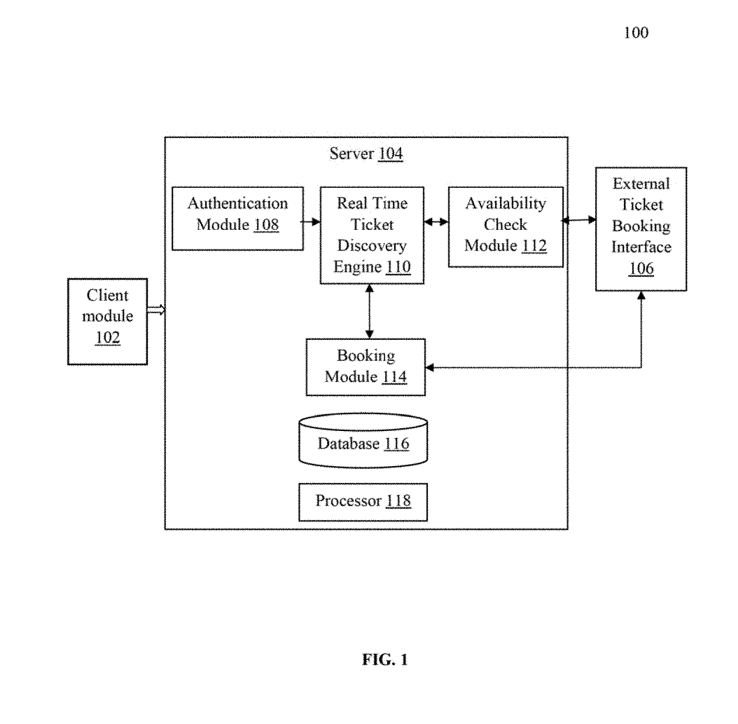

FIG. 1 illustrates a block diagram of a system for effective discovery and booking of travel options between a source and destination pair, according to one embodiment herein. The system comprises the client module 102, the server 104 and the external ticket booking interface 106. The server 104 further comprises the authentication module 108, the real time ticket discovery engine 110, the availability check module 112, the booking module 114 and the database 116.

According to an embodiment herein, the client module 102 is configured for enabling one or more users to specify one or more travel journey related details. The one or more travel journey related details comprise name of a source station, name of a destination station, preferred time and date of travel and preferred mode of transport and the like.

According to an embodiment herein, the server 104 comprises the processor 118 configured for processing the requests received from the authentication module 108, the real time ticket discovery engine 110, the availability check module 112, the booking module 114 and the database 116.

According to an embodiment herein, the authentication module 108 is configured for authenticating each user using one or more personal details provided by the user. The one or more personal details comprise a mobile number, Facebook credentials, Google credentials and the like. The authentication module 108 is further configured for generating a unique token number for identifying each user associated with the system.

According to an embodiment herein, the real time ticket discovery engine 110 is configured for searching one or more available travel options for the user to reach the destination station based on seat availability in one or more modes of transport between the source station and the destination station. The real time ticket discovery engine 110 is further configured for preparing and sharing a travel itinerary with the user from source station to destination station by chaining one or more modes of transport based on seat availability.

According to an embodiment herein, the real time ticket discovery engine 110 is further configured for searching the one or more available travel options for the user based on one or more factors. The one or more factors comprise fastest way to reach the destination station, waiting time, number of hops, cheaper mode of transport, convenience for the user and the preference of the user. In one example embodiment, the real time ticket discovery engine 110 performs a search for tickets on same train by exploring one or more quotas available for all the station combinations. This results in three possible options for ticket booking which are booking from new source but mentioning boarding point to the actual source station, booking till new destination while dropping at actual destination and booking from new source station to new destination station but mentioning boarding point as actual source and dropping at actual destination. In another example embodiment, several break journey options are provided to the user. The several break journey options comprise train+train, train+bus, bus train, bus+bus, train+flight, flight+train, flight+bus, bus+flight and the like. In yet another example embodiment, when no tickets are available or no any mode of transport is available between the source and destination station then the real time ticket discovery engine 110 searches for nearby stations from the source/destination station.

According to an embodiment herein, the availability check module 112 is configured for checking and retrieving seat availability data from a plurality of ticket booking portals for one or more modes of transport and providing the retrieved data to the real time ticket discovery engine 110.

According to an embodiment herein, the booking engine 114 is configured for booking one or more tickets for the user based on the most suitable travel option selected by the user. One or more details related to the booked ticket are stored in a database 116.

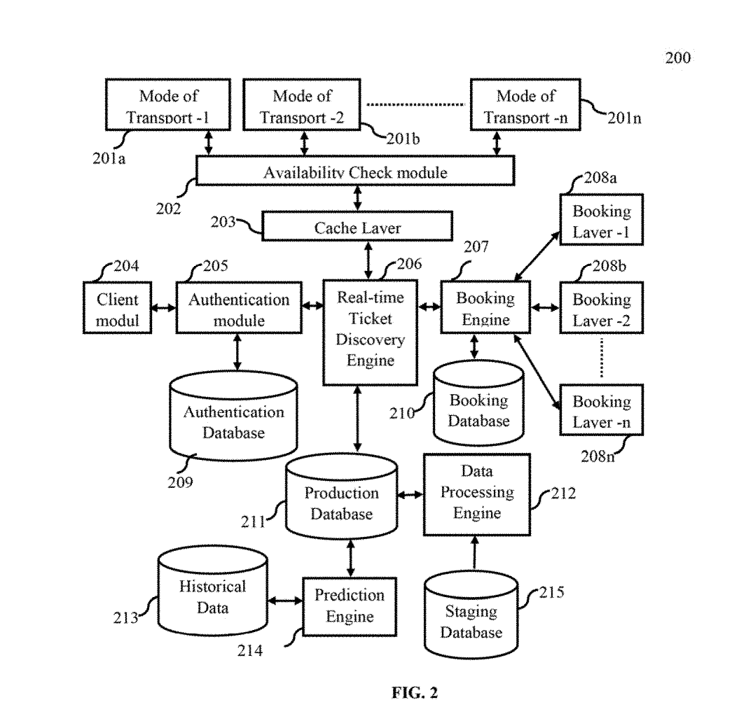

FIG. 2 illustrates a detailed block diagram of a system for effective discovery and booking of travel options between a source and destination pair, according to one embodiment herein. The system comprises the plurality of choice of modes of transport 201a, 201b, . . . , 201n, the availability check module 202, the cache analyzer 203, the client module 204, the authentication module 205, the real-time ticket discovery engine 206 the booking engine 207, the plurality of booking layers 208a, 208b, . . . , 208n, the authentication database 209, the booking database 210, the production database 211, the data processing engine 212, the historical data store 213, the prediction engine 214 and the staging database 215.

According to an embodiment herein, the cache layer 203 is configured for storing plurality of details related to one or nodes of transport associated with the system. The plurality of details comprises schedule and seat availability for each mode of transport. The cache layer 203 is further configured for caching the plurality of details related to one or more modes of transport for a pre-determined period of time.

According to an embodiment herein, the historical data store 213 is configured for storing historical data related to availability of tickets, change of ticket status, price of tickets, delay in arrival/departure of the selected mode of transport and preferred mode of transport for each user.

According to embodiment herein, the staging database 215 is configured for raw data collected from all the ticket booking portals associated with the system. The data processing engine 212 is further configured for moving the raw data to a production database 211 after cleansing, processing and validation.

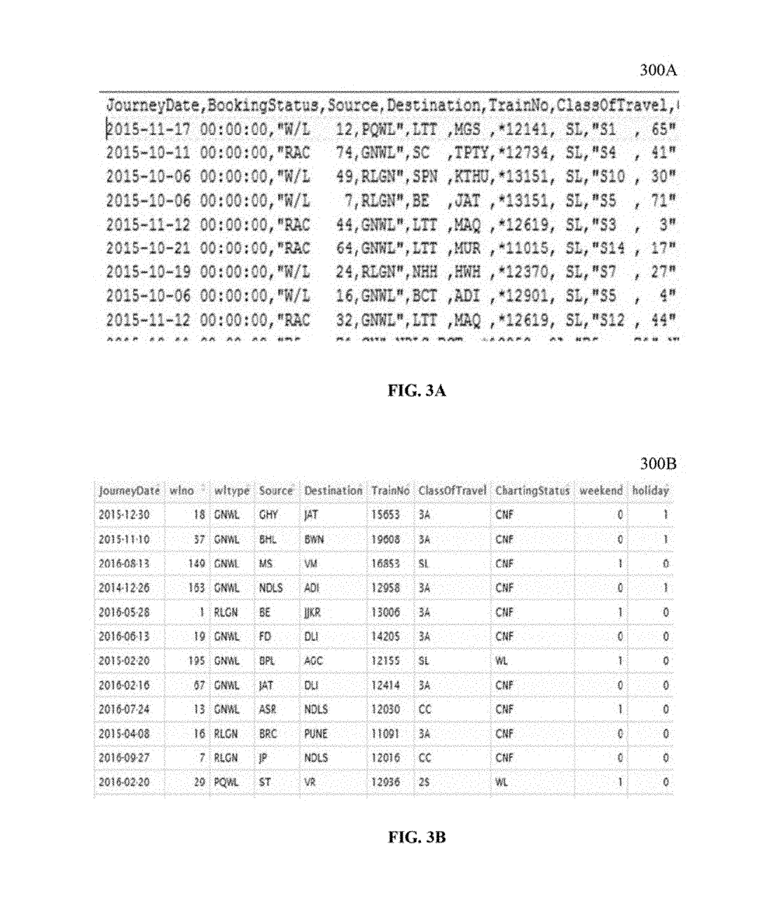

According to an embodiment herein, the data processing engine 212 is configured for processing a logged historical passenger name record number (PNR) data available from one or more ticket booking portals along with plurality of journey details for one or more users to determine trends related to confirmation of wait-listed tickets for a particular mode of transport. FIG. 3A illustrates an example historical passenger name record number (PNR) data procured using a train ticket booking portal. The plurality of journey details comprise class of travel, booking status, journey date, quota and final charting status. The data processing engine 212 is further configured for grouping the historical passenger name record number (PNR) data into one or more groups and marking whether particular ticket is confirmed or wait-listed as shown in FIG. 3B. The one or more groups comprise a weekend season group, a normal season group, a holiday season group, a quota-wise group and a class-wise group.

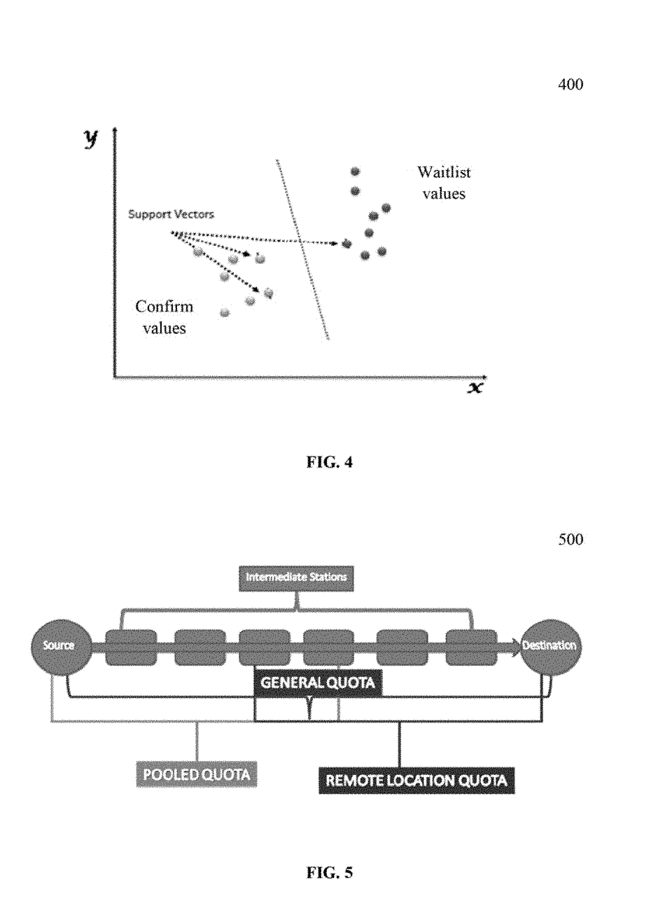

According to an embodiment herein, the prediction engine 214 is configured for processing the historical passenger name record number (PNR) data to determine a threshold cancellation value related to each mode of transport using one or more machine learning algorithms. The threshold cancellation value is used for determining the chances of a ticket booking getting confirmed. In one example embodiment a support vector machine (SVM) algorithm is used by the prediction engine 214 to find the threshold cancellation value of each group. Here, each data item is plotted as a point in n-dimensional space (where n is number of features) with the value of each feature being the value of a particular coordinate (as shown in FIG. 4). A classification is performed by finding a hyper-plane that differentiates the two classes as CONFIRM OR WAITLIST. The point in the left of hyper plane represents a threshold value where more number of tickets are confirmed for this threshold point. For a particular query received, the threshold cancellation value for that group is searched using the prediction engine 214. When the present value is noted to be less than the threshold cancellation value then the chances of ticket confirmation are assumed to be higher.

According to an embodiment herein, the system is further configured for identifying one or more stations for which the seat availability changes by changing the source station and by keeping the destination station constant and vice versa. The identified one or more stations are marked with a data change flag. The one or more stations marked using data change flag are used by the real time ticket discovery engine for determining seat availability between a source station to a destination station, a source station to an intermediate station and an intermediate station to a destination station.

In one example embodiment, the information of marked station with data change flag is used for providing different booking options to the user between source and destination station. Consider a train having 1000 seats and going to 10 stations. The train booking portal allocates these 1000 seats in a quota wise manner such as 500 seats for users travelling from source to destination (general quota), 300 seats for users travelling from source to intermediate stations (pooled quota) and 200 seats for users travelling from the intermediate station to destination (remote location quota) as shown in FIG. 5. Thus, the stations where the quotas are changing are identified using the data change flag for each train. Here, the user wanting to go from intermediate station to destination falls under remote location quota which has 200 seats. When all 200 seats are booked, waitlist tickets for this quota are booked. So availability from source to destination which has 500 seats in general quota is searched. In case the seats are available in general quota then the user books ticket from source to destination instead of booking from intermediate Station.

Similarly, for user searching for ticket from source to destination under pooled quota with 300 seats, when all 300 seats are booked then waitlist tickets for this quota are booked. So availability from source to destination with 500 seats in general quota is searched. In case seats are available then user books ticket from source to destination instead of booking from source to intermediate station.

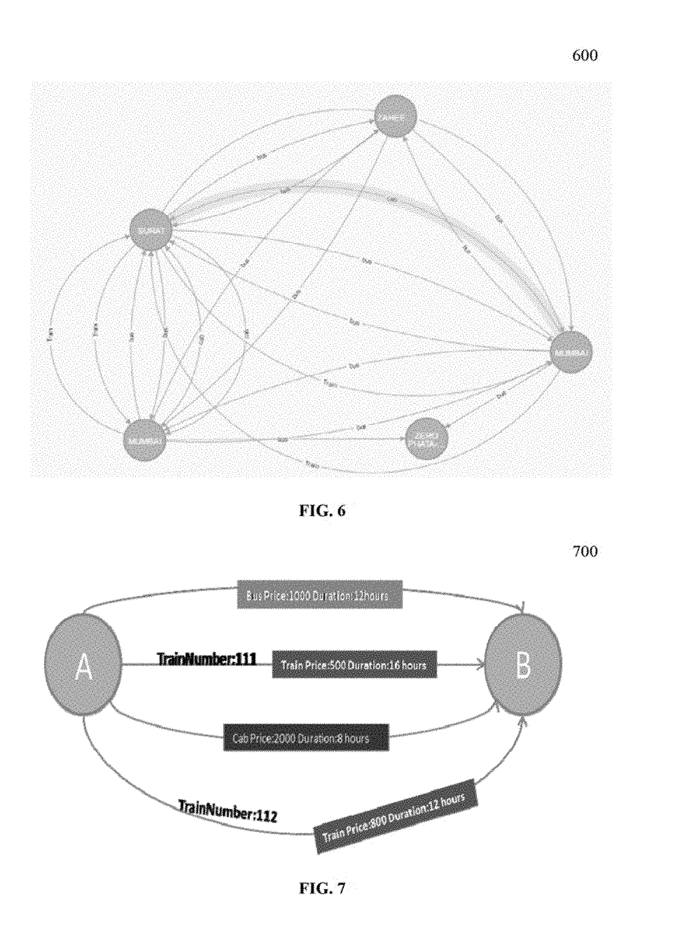

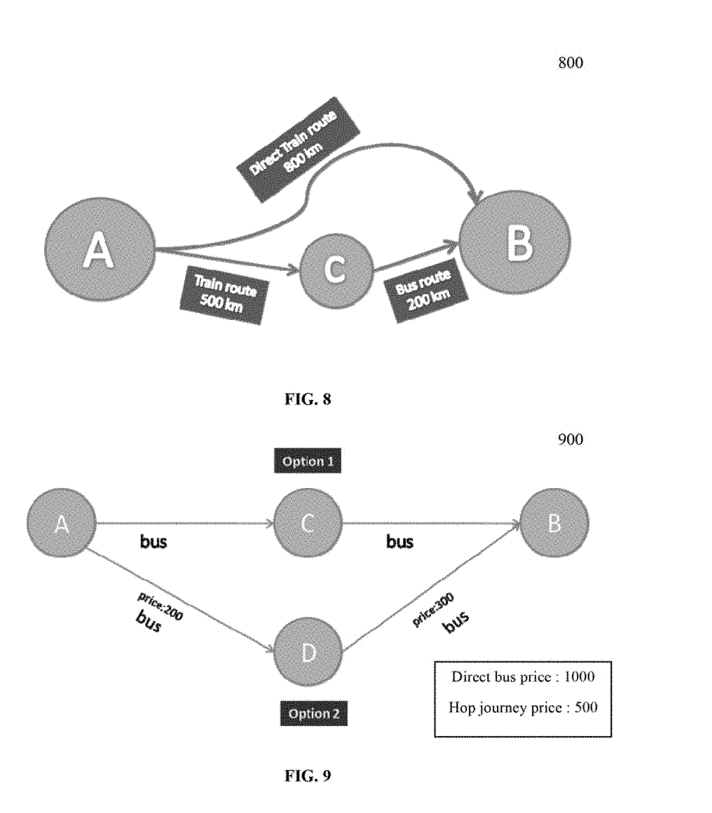

According to an embodiment herein, the real time ticket discovery engine is further configured for searching the one or more available travel options for the user using a graph data structure. The graph data structure comprises a connected graph with plurality of nodes representing one or more hop/intermediate stations between the source station and the destination station as shown in FIG. 6. In many cases, train and bus routes do not match. In such situations all best possible travel options are searched. For example, suppose user wants to travel from point A to point B. Then the system searches for all possible routes between A and B with best options like fastest, low price with availability in buses, trains etc. as shown in FIG. 7. In some cases, for a particular source and destination only train routes might be available. The direct train route might take longer duration as compared to hop journey. In such situation the system suggests hop journey options to the user covering the distance by taking shortest route as shown in FIG. 8. Similarly, in busy seasons when bus ticket prices are sky rocketing then the system searches for low price options to reach the destination with hop journey as shown in FIG. 9.

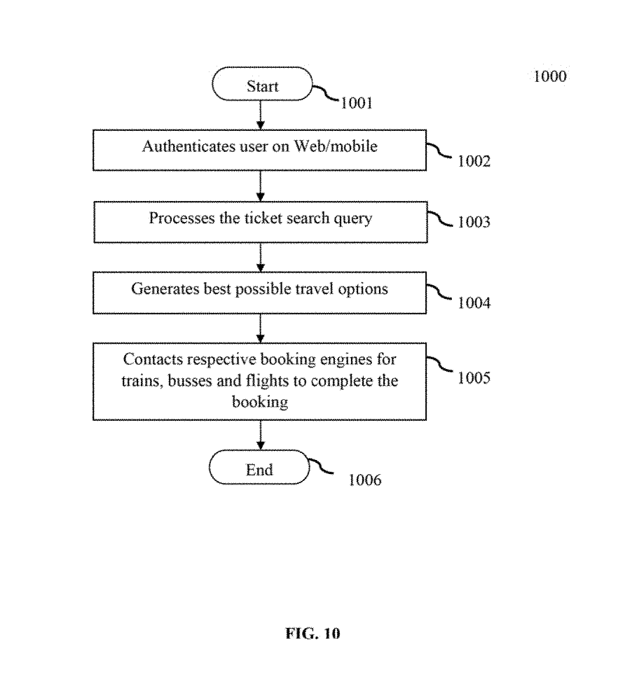

FIG. 10 illustrates a flowchart explaining the method for effective discovery of travel options between a source and destination pairs, according to one embodiment herein. The flow comprises the following steps: Start (1001); Authenticate user on web or mobile interface (1002); Process the ticket search query (1003); Generate best possible travel options (1004); Contact respective booking engines for a plurality of modes of transport to complete the booking (1005); and, end the process (1006).

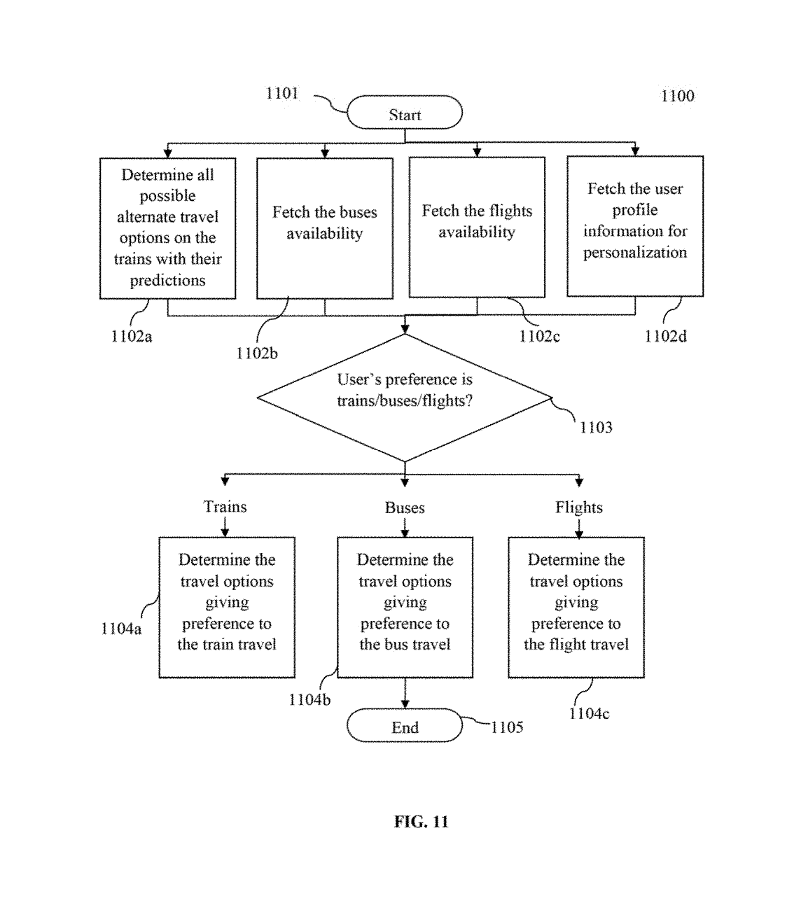

FIG. 11 illustrates an exemplary method of travel option determination, according to one embodiment herein. The method comprises the following steps: Start (1101); Determine all travel options in trains with predictions (1102a); Determine all travel options in bus with predictions (1102b); Determine all travel options in flight with predictions (1102c); Fetch user profile information for personalization (1102d); Determine the preference of user (1103); If user preferred mode of transport is train, determine travel options giving preference to train travel (1104a); If user preferred mode of transport is bus, determine travel options giving preference to bus travel (1104b); If user preferred mode of transport is flight, determine travel options giving preference to flight travel (1104c); and, end the process (1105).

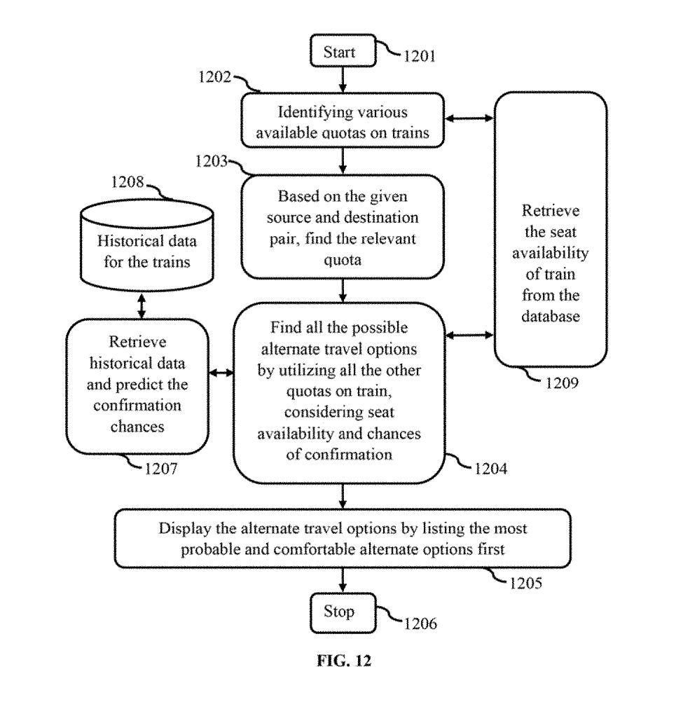

FIG. 12 illustrates an exemplary method for determining alternate ticketing options in a same train, according to one embodiment herein. The method comprises following steps; Start (1201); Identify various available quotas on trains (1202) by retrieving the seat availability of train from the database (1209); Based on the given source and destination pair, find the relevant quota (1203); Find all the possible alternate travel options by utilizing all the other quotas on train, considering seat availability and chances of confirmation (1204). The alternate travel options are determined by accessing Historical data for the trains (1208), retrieving historical data and predict the confirmation chances (1207), and retrieving the seat availability of train from the database (1209); Display the alternate travel options by listing the most probable and comfortable alternate options first (1205); and, stop the process (1206).

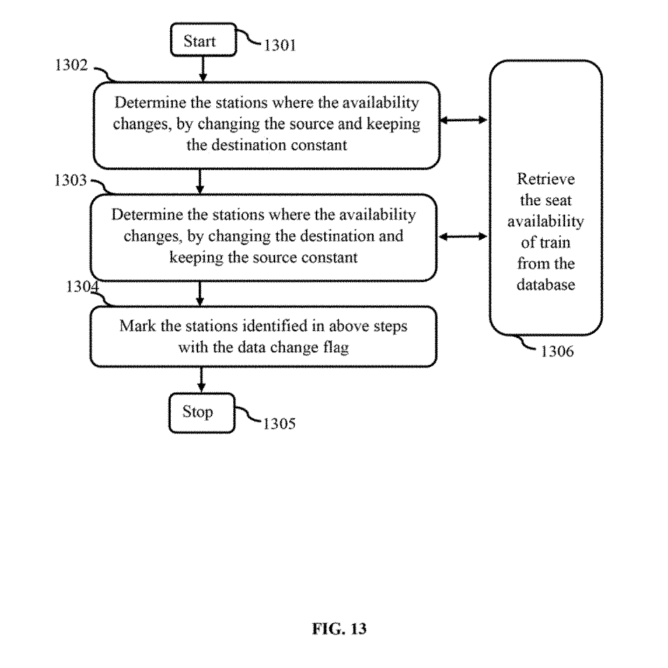

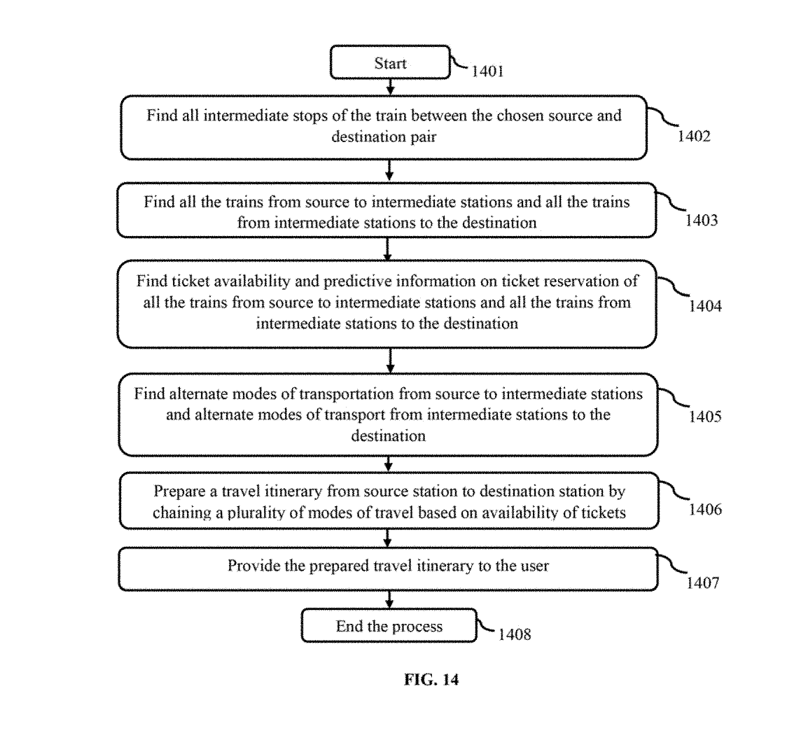

FIG. 13 illustrates a flow diagram that enables marking data change flags, according to one embodiment herein. The method comprises following steps: Start (1301); Determine the stations where the availability changes by changing the source and keeping the destination constant (1302) by retrieving the seat availability of train from the database (1304); Determine the stations where the availability changes, by retrieving the seat availability of train from the database (1306) and, by changing the destination and keeping the source constant (1303); mark the stations identified in above steps with the data change flag (1304); and, stop the process (1305).

FIG. 14 illustrates an exemplary method for determining alternate ticketing options in a plurality of erodes of transport, according to one embodiment herein. The method comprises the following steps: Start (1401); Find all intermediate stops of the train between the chosen source and destination pair (1402); Find all the trains from source to intermediate stations and all the trains from intermediate stations to the destination (1403); Find ticket availability and predictive information on ticket reservation of all the trains from source to intermediate stations and all the trains from intermediate stations to the destination (1404); Find alternate modes of transportation from source to intermediate stations and alternate modes of transport from intermediate stations to the destination (1405); Prepare a travel itinerary from source station to destination station by chaining a plurality of modes of travel based on availability of tickets (1406); Provide the prepared travel itinerary to the user (1407); and, End the process (1408).

Therefore, the system and method for effective discovery of travel options between a source and destination pair provided an effective utilization of unused reservation quotas in a plurality of modes of travel. Currently, there are no systems available to enable travelers with information on alternative quotas and reservation options between a source and destination pair, which creates a situation wherein, even though vacancy is open for tickets between a source and destination pair, travelers are not aware of the vacant tickets. This leads to the travelers choosing a less preferred mode of travel and an ineffective utilization of ticket reservation options. The system and method utilizes graph data-structure to determine the available travel options between given source and destination pair is provided. The system and method enables travelers to reserve tickets by connecting or chaining multiple vehicles in the same or different modes of travel between given source and destination pair. The system also enables an effective travel solution by identifying a plurality of journey break options on a plurality of modes of travel between a given source and destination pair. The travelers are provided with information on all available travel options between a source and destination pair in a plurality of erodes of travel.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A system comprising a hardware processor and a memory storing instructions that are run on the hardware processor for effective detection, identification and booking of travel options between a source and a destination pair, the system comprising:
a client module configured for enabling one or more users to specify one or more travel journey related details, and wherein the one or more travel journey related details comprise name of a source station, name of a destination station, preferred time and date of travel and preferred mode of transport;
a server communicatively coupled to the client module, and wherein the server is configured for presenting one or more available travel options to the user and for booking travel tickets for most suitable travel option selected by the user, and wherein a travel option comprises a direct travel or a break journey with one or more hops between source station and destination station using one or more modes of transport, and wherein the one or more modes of transport comprise train, bus, taxi and flight;
an authentication module provided in the server and run on a hardware processor, and wherein the authentication module is configured for authenticating each user using one or more personal details provided by the user, and wherein the one or more personal details comprise a mobile number, Facebook credentials and Google credentials, and wherein the authentication module is further configured for generating a unique token number for identifying each user associated with the system;
a real time ticket discovery engine provided in the server and run on a hardware processor, and wherein the real time ticket discovery engine is configured for searching one or more available travel options for the user to reach the destination station based on seat availability in one or more modes of transport between the source station and the destination station, and wherein the real time ticket discovery engine is further configured for preparing and sharing a travel itinerary with the user from source station to destination station by chaining one or more modes of transport based on seat availability;
an availability check module provided in the server and run on a hardware processor, and wherein the availability check module is configured for checking and retrieving seat availability data from a plurality of ticket booking portals for one or more modes of transport and providing the retrieved data to the real time ticket discovery engine; and
a booking engine provided in the server and run on a hardware processor, and wherein the booking engine is configured for booking one or more tickets for the user based on the most suitable travel option selected by the user, and wherein one or more details related to the booked ticket are stored in a database.

2. The system according to claim 1, wherein the real time ticket discovery engine is further configured for searching an alternate option to reach the destination station in case no seats are available in any mode of transport, and wherein the alternate option to reach the destination station comprise a wait listed ticket in one or more modes of transport with highest chances of confirmation, a hop journey using a combination of more than one modes of transport and a longer route with confirmed tickets.

3. The system according to claim 1, wherein the system further comprises a historical data store configured for storing historical data related to availability of tickets, change of ticket status, price of tickets, delay in arrival/departure of the selected mode of transport and preferred mode of transport for each user.

4. The system according to claim 1, wherein the system further comprises a data processing engine configured for processing a logged historical passenger name record number (PNR) data available from one or more ticket booking portals along with plurality of journey details for one or more users to determine trends related to confirmation of wait-listed tickets for a particular mode of transport, and wherein the plurality of journey details comprise class of travel, booking status, journey date, quota and final charting status, and wherein the data processing engine is further configured for grouping the historical passenger frame record number (PNR) data into one or more groups and marking whether particular ticket is confirmed or wait-listed, and wherein the one or more groups comprise a weekend season group, a normal season group, a holiday season group, a quota-wise group and a class-wise group.

5. The system according to claim 1, wherein the system further comprises a prediction engine configured for processing the historical passenger name record number (PNR) data logged using the data processing engine to determine a threshold cancellation value related to each mode of transport using one or more machine learning algorithm, and wherein the threshold cancellation value is used for determining the chances of a ticket booking getting confirmed.

6. The system according to claim 1, wherein the system further comprises a staging database configured for storing raw data collected from all the ticket booking portals associated with the system, and wherein the data processing engine is further configured for moving the raw data to a production database after cleansing, processing and validation.

7. The system according to claim 1, wherein the system further comprises a cache layer configured for storing plurality of details related to one or more modes of transport associated with the system, and wherein the plurality of details comprises schedule and seat availability for each mode of transport, and wherein the cache layer is further configured for caching the plurality of details related to one or more modes of transport for a pre-determined period of time.

8. The system according to claim 1, wherein the real time ticket discovery engine is further configured for searching the one or more available travel options for the user based on one or more factors, and wherein the one or more factors comprise fastest way to reach the destination station, waiting time, number of hops, cheaper mode of transport, convenience for the user and the preference of the user.

9. The system according to claim 1, wherein the system is further configured for identifying one or more stations for which the seat availability changes by changing the source station and by keeping the destination station constant and vice versa, and wherein the identified one or more stations are marked with a data change flag, and wherein the one or more stations marked using data change flag are used by the real time ticket discovery engine for determining seat availability between a source station to a destination station, a source station to an intermediate station and an intermediate station to a destination station.

10. The system according to claim 1, wherein the system is further configured for utilizing unused reservation quotas/tickets available in special category between the source station and the destination station in one or more modes of transport, and wherein reservation quota/special category comprises reservation quota, senior citizen quota, ladies quota, very important people (VIP) quota and military quota.

11. The system according to claim 1, wherein the real time ticket discovery engine is further configured for searching the one or more available travel options for the user using a graph data structure, and wherein the graph data structure comprises a connected graph with plurality of nodes representing one or more hop/intermediate stations between the source station and the destination station.

12. The system according to claim 1, wherein the system is further configured for sharing one or more predictions with the user about a status of a travel ticket getting confirmed from an unconfirmed status based on analysis of historical data on ticket confirmation.

13. The system according to claim 1, wherein the system is further configured for providing a Web interface or a mobile interface to the one or more users for effective discovery and booking of one or more travel options between the source station and the destination station.

14. A computer implemented method comprising instructions stored on a non-transitory computer readable storage medium and run a computing device provided with a hardware processor and memory for effective detection, identification and booking of travel options between a source and destination pair, the method comprising the steps of:
enabling one or more users to specify one or more travel journey related details using a client module, and wherein the one or more travel journey related details comprise name of a source station, name of a destination station, preferred time and date of travel and preferred mode of transport;
authenticating one or more users using one or more personal details using an authentication module, and wherein the one or more personal comprise a mobile number, Facebook credentials and Google credentials;
searching one or more available travel options for the user to reach the destination station based on seat availability in one or more modes of transport between the source station and the destination station using a real time ticket discovery engine, and wherein the one or more modes of transport comprise train, bus, taxi and flight;
preparing and sharing a travel itinerary with the user from source station to destination station by chaining one or more modes of transport based on availability of tickets using the real time ticket discovery engine;
checking and retrieving seat availability data from a plurality of ticket booking portals for one or more modes of transport and providing the retrieved data to the real time ticket discovery engine using an availability check module; and
booking one or more tickets for the user based on the most suitable travel option selected by the user, and wherein one or more details related to the booked ticket are stored in a database.

15. The method according to claim 14, further comprises searching an alternate option to reach the destination station in case no seats are available in any mode of transport, and wherein the alternate option to reach the destination station comprise a wait listed ticket in one or more modes of transport with highest chances of confirmation, a hop journey using a combination of more than one modes of transport and a longer route with confirmed tickets.

16. The method according to claim 14, further comprises processing a logged historical passenger name record number (PNR) data available from one or more ticket booking portals along with plurality of journey details for one or more users to determine trends related to confirmation of wait-listed tickets for a particular mode of transport using a data processing engine, and wherein the plurality of journey details comprise class of travel, booking status, journey date, quota and final charting status.

17. The method according to claim 14, further comprises grouping the historical passenger name record number (PNR) data into one or more groups and marking whether particular ticket is confirmed or wait-listed, and wherein the one or more groups comprise a weekend season group, a normal season group, a holiday season group, a quota-wise group and a class-wise group.

18. The method according to claim 14, further comprises processing the historical passenger name record number (PNR) data logged using the data processing engine to determine a threshold cancellation value related to each mode of transport using one or more machine learning algorithms through a prediction engine, and wherein the threshold cancellation value is used for determining the chances of a ticket booking getting confirmed.

19. The method according to claim 14, further comprises searching the one or more available travel options for the user based on one or more factors, and wherein the one or more factors comprise fastest way to reach the destination station, waiting time, number of hops, cheaper mode of transport, convenience for the user and the preference of the user.

20. The method according to claim 14, further comprises identifying one or more stations for which the seat availability changes by changing the source station and by keeping the destination station constant and vice versa, and wherein the identified one or more stations are marked with a data change flag, and wherein the one or more stations marked using data change flag are used by the real time ticket discovery engine for determining seat availability between a source station to a destination station, a source station to an intermediate station and an intermediate station to a destination station.
